(19) United States
(12) Patent Application Publication
(10) Pub. No.: US 2013/0335340 A1
(43) Pub. Date: Dec. 19, 2013

(54) CONTROLLING DISPLAY OF IMAGES RECEIVED FROM SECONDARY DISPLAY DEVICES

(71) Applicant: Jeffrey J. Smith, Raleigh, NC (US)

(72) Inventor: Jeffrey J. Smith, Raleigh, NC (US)

(73) Assignee: INTERNATIONAL BUSINESS MACHINES CORPORATION, Armonk, NY (US)

(21) Appl. No.: 13/527,554

(22) Filed: Jun. 19, 2012

(51) Int. Cl. G06F 3/041

(52) U.S. Cl. 345/173

(57) ABSTRACT

Disclosed herein are systems and methods for controlling display of images received from secondary display devices. In accordance with embodiments of the present invention, a method includes controlling a first display to display a first image. The method may also include receiving predetermined touch input via the first display. Further, the method may include controlling the first display to display a second image that is substantially the same as a third image displayed on a second display in response to receiving the predetermined touch input.

### BACKGROUND

1. Field of the Invention

The present invention relates to displays, and more specifically, to controlling display of images received from secondary display devices.

2. Description of Related Art

Many computing systems have multiple displays for presentation of images, such as pictures, text, and the like, to different users. For example, in an office environment, a local area network may connect multiple computers to form a computing system. Each of the computers may include a display for presentation of images to its user. In another example, a single computing device, such as a point of sale (POS) terminal in a retail environment, may have multiple displays with one display facing a shopper and another display facing retail personnel. In this example, the different displays may be controlled by a single processing unit, and yet the displays may display different images to the users at any time. In yet another example, mobile computing devices may be communicatively linked and may display different images on their displays.

In some instances, a computing device user may desire to see the images currently being displayed on the computing device of another user. For example, in a retail environment, retail personnel may desire to view images, such as transaction data, being displayed on a shopper's display. Accordingly, it is desired to provide convenient and efficient techniques for allowing a computing device user to selectively display images being displayed on the display of another user's computing device.

### BRIEF SUMMARY

Disclosed herein are systems and methods for controlling display of images received from secondary display devices. According to an aspect, a method includes controlling a first display to display a first image. The method may also include receiving predetermined touch input via the first display. Further, the method may include controlling the first display to display a second image that is substantially the same as a third image displayed on a second display in response to receiving the predetermined touch input.

### BRIEF DESCRIPTION OF THE SEVERAL VIEWS OF THE DRAWINGS

FIG. 1 is a block diagram of an example system for controlling display of an image received from a secondary display in accordance with embodiments of the present invention;

FIG. 2 is a flowchart of an example method for controlling display of images received from a secondary display device in accordance with embodiments of the present invention;

FIGS. 3A and 3B depict movement diagrams of example multi-touch gestures in accordance with embodiments of the present invention;

FIG. 4 is a block diagram of another example system for controlling display of an image received from a secondary display in accordance with embodiments of the present invention; and

FIG. 5 illustrates a flowchart of another example method for controlling display of images received from a secondary display device in accordance with embodiments of the present invention.

### DETAILED DESCRIPTION

Exemplary systems and methods for controlling display of images received from secondary display devices in accordance with embodiments of the present invention are disclosed herein. Particularly, disclosed herein is a system configured to control a first display to display a first image, to receive predetermined touch input via the first display, and to control the first display to display a second image that is substantially the same as a third image display on a second display in response to receiving the predetermined touch input. In an example, the system may be implemented in a retail environment or a “brick and mortar” store having a variety of products for browse and purchase by a customer. In an example, the systems and methods disclosed herein may be implemented within a computing device, such as a point of sale (POS) terminal located in a retail environment. In another example, the systems and methods disclosed herein may be implemented within different computing devices that each have a display. A user may enter touch input into one display for displaying an image being displayed on another display. For example, the user may make a particular multi-touch gesture on the display to control the display to display the image. The user may enter a similar or other predetermined touch input for stopping display of the image.

As referred to herein, the term “computing device” should be broadly construed. It can include any type of device capable of displaying images. For example, the computing device may be a smart phone including a camera configured to capture one or more images of a product. The computing device may be a mobile computing device such as, for example, but not limited to, a smart phone, a cell phone, a pager, a personal digital assistant (PDA, e.g., with GPRS NIC), a mobile computer with a smart phone client, or the like. A computing device can also include any type of conventional computer, for example, a laptop computer or a tablet computer. A typical mobile electronic device is a wireless data access-enabled device (e.g., an iPHONE® smart phone, a BLACKBERRY® smart phone, a NEXUS ONE™ smart phone, an iPAD® device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on smart phone, the examples may similarly be implemented on any suitable computing device, such as a computer.

As referred to herein, the term “user interface” is generally a system by which users interact with a computing device. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of an electronic device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

As referred to herein, the term “touch screen display” should be broadly construed. It can include any type of device capable of displaying images and capable of detecting the presence and location of a touch within the display screen. The term “touch input” generally refers to touching the display screen with a finger or hand. Such displays may also sense other passive objects, such as a stylus.

As referred to herein, the term “multi-touch gesture” should be broadly construed. The term can refer to a specific type of touch input in which a user touches a display screen with two or more points of contact. In this example, the display screen is capable of recognizing the presence of the two or more points of contact.

As referred to herein, the terms “transaction data” should be broadly construed. For example, transaction data may include, but is not limited to, any type of data that may be used for conducting a purchase transaction. Exemplary transaction data includes a purchase item identifier, discount information for a purchase item (e.g., coupon information for a purchase item), shopper profile information, transaction security information, payment information, purchase item information, and the like. Transaction data may also include, but is not limited to, any type of data relevant to a shopper or collected by a mobile computing device while a shopper is shopping.

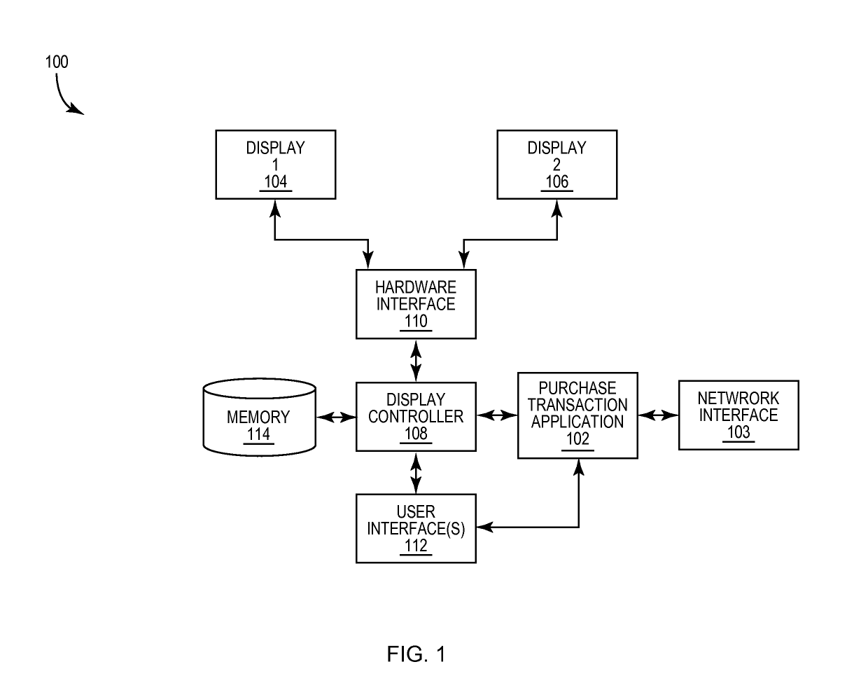

FIG. 1 illustrates a block diagram of an example system 100 for controlling display of an image received from a secondary display in accordance with embodiments of the present invention. The system 100 may be implemented in whole or in part in any suitable retail environment. For example, the system 100 may be implemented in a retail store having a variety of products positioned throughout the store for browse and purchase by customers. Customers may collect one or more of the products for purchase and proceed to the system 100, which may be a point of sale (POS) terminal, to conduct a suitable purchase transaction for purchase of the products. Purchase transactions may be implemented in whole or in part by a purchase transaction application 102. For example, the purchase transaction application 102 may be hardware, software, and/or firmware configured to receive identifications of products and to receive, process, and generate transaction data. For example, the application 102 may be implemented by one or more processors and memory. The purchase transaction application 102 may control a network interface 103 to interact with a network to communicate with a financial services server for conducting a purchase transaction.

Displays 1 104 and 2 106 may display transaction data such as, for example, but not limited to, product identification information, prices, financial information, and the like. In this example, display 104 may be positioned to face a shopper, and display 106 may be positioned to face retail personnel. One or both of the displays 104 and 106 may be touch screen displays for allowing the shopper and/or retail personnel to enter touch input on their respective display.

A display controller 108 and hardware interface 110 may be configured to control the displays 104 and 106 to display images such as, text, pictures, and the like. The display controller 108 may be implemented by hardware, software, and/or firmware. For example, the display controller 108 may be implemented by one or more processors and memory. The hardware interface 110 may communicate with the displays 104 and 106 to receive touch contacts and movements from the display 104 and 106. In addition, the hardware interface 110 may receive control commands from the display controller 108 for controlling the display of images on the displays 104 and 106.

The hardware interface 110 may include several subcomponents that are configured to provide touch input information. For example, the display controller 108 may provide a common driver model for single-touch and multi-touch hardware manufacturers to provide touch information for their particular hardware. The display controller 108 may translate touch information received from the hardware interface 110 into data for use in conducting purchase transactions. Further, the display controller 108 may translate display information received from the purchase transaction application 102 and one or more user interfaces 112 into data for controlling the display 104 and 106 to display images.

The system 100 may include one or more other user interfaces 112 configured to be interacted with by one or both of the shopper and the retail personnel. The user interface(s) 112 may be used for presenting transaction data and/or for allowing users to enter information for conducting a transaction or other operation with the retail environment. Example user interfaces include, but are not limited to, a keyboard, mouse, magnetic stripe reader, bar code reader, and the like.

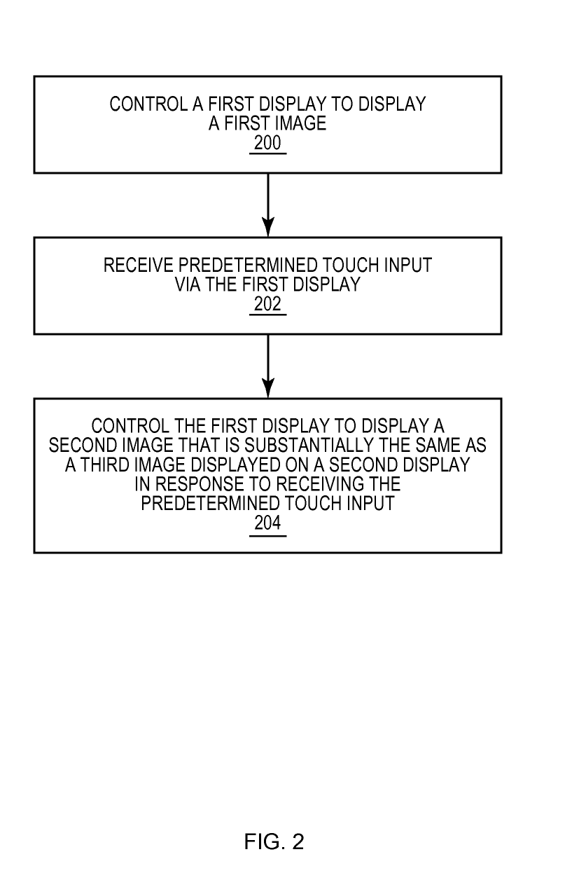

FIG. 2 illustrates a flowchart of an example method for controlling display of images received from a secondary display device in accordance with embodiments of the present invention. The method of FIG. 2 is described as being implemented by the system 100 shown in FIG. 1, although the method may be implemented by any suitable system. The method may be implemented by hardware, software, and/or firmware of the system 100 or any suitable computing device, such as a POS terminal and a mobile computing device.

Referring to FIG. 2, the method includes controlling 200 a first display to display a first image. For example, the display controller 108 and hardware interface 110 can control the display 104 to display images related to a purchase transaction. In this example, the display 104 may be positioned for view by and interaction with a cashier. The cashier may be positioned at a POS location for checking out shoppers within a retail environment. Instructions or data for display of the images may be provided to the display controller 108 by the purchase transaction application 102.

The method of FIG. 2 includes receiving 202 predetermined touch input via the first display. Continuing the aforementioned example, the cashier may touch the touch screen of the display 104 for entering predetermined touch input. In an example, the touch input may be any suitable touch gesture on the surface of the touch screen that is recognizable by the display controller 108 and/or hardware interface 110. Example touch input gestures include, but are not limited to, multi-touch gesture, tap/double tap, panning with inertia, selection/draft, press and tap, zoom, rotate, two-finger tap, press and hold, flicks, and the like. A multi-touch gesture may be a multi-touch drag contact of the display screen of the display 104. The touch input may be made on a particular area of the touch screen or any area of the touch screen. The display 104 may receive the touch input and communicate data corresponding to the touch input to the hardware interface 110 in response to receipt of the touch input.

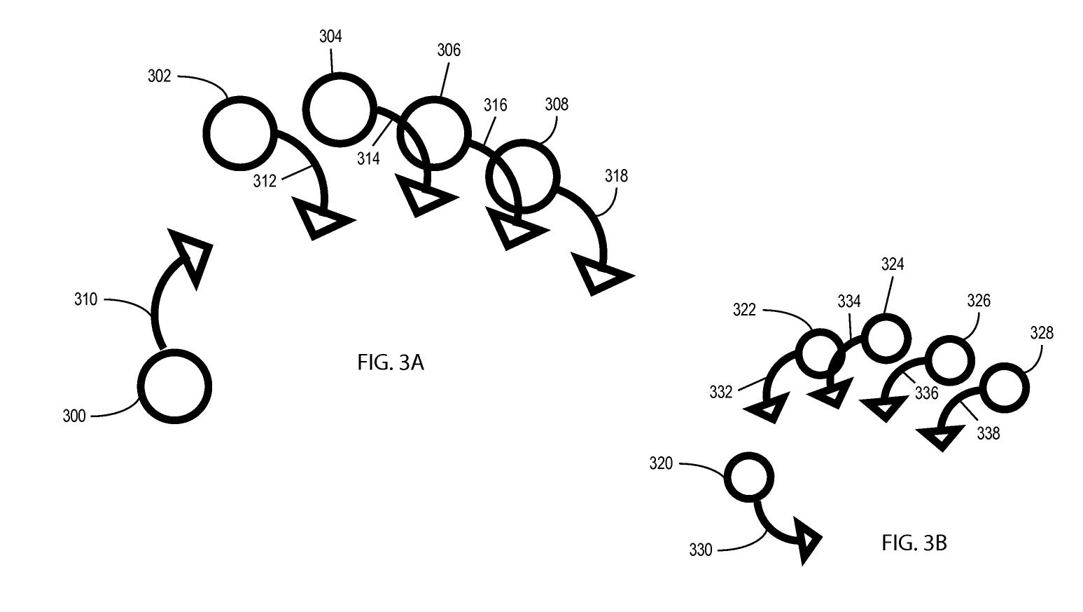

FIGS. 3A and 3B illustrate movement diagrams of example multi-touch gestures in accordance with embodiments of the present invention. Referring to FIG. 3A, circles 300, 302, 304, 306, and 308 show locations of initial placement of fingertips on a screen display for beginning the multi-touch gesture. For example, a thumb may be placed at circle 300 and other fingers of the same hand may be placed at circles 302-308. Direction arrows 310, 312, 314, 316, and 318 show directions of drag movement of fingers at circles 300, 302, 304, 306, and 308, respectively, as a second step in the multi-touch gesture. Drag movement of fingers in these directions and subsequent withdrawal of the fingers from the touch screen completes the multi-touch gesture.

Similar to the multi-touch gesture shown in FIG. 3A, the multi-touch gesture shown in FIG. 3B includes circles 320, 322, 324, 326, and 328 that depict locations of initial placement of fingertips on a screen display for beginning the multi-touch gesture. For example, a thumb may be placed at circle 320 and other fingers of the same hand may be placed at circles 322-328. Direction arrows 330, 332, 334, 336, and 338 show directions of drag movement of fingers at circles 320, 322, 324, 326, and 328, respectively, as a second step in the multi-touch gesture. Drag movement of fingers in these directions and subsequent withdrawal of the fingers from the touch screen completes the multi-touch gesture. This multi-touch gesture may be used to reverse the gesture of FIG. 3A in order to return the display to its original view.

In accordance with embodiments of the present invention, the multi-touch gestures of FIGS. 3A and 3B may be used to cycle through multiple different displays of other users (e.g., shoppers). In this way, gestures can be made to efficiently cycle through the displays of multiple different shoppers.

Returning to FIG. 2, the method includes controlling 204 the first display to display a second image that is substantially the same as a third image displayed on a second display. Continuing the aforementioned example, the display controller 108 may use the touch input perform a lookup in memory 114. For example, multiple predetermined touch input commands may be stored in the memory 114. The display controller 108 may determine whether the touch input matches one of the stored touch input commands. In this example, the touch input corresponds to a command for controlling the display 104 to display an image that is substantially the same as an image being displayed on the display 106. In response to determining that the touch input corresponds to this command, the hardware interface 110 may access an image being displayed on the display 106 and display the accessed image on the display 104. Thus, in this example, the cashier may enter the touch input on the display 104 for displaying an image on the cashier's display 104 that is being displayed on the shopper's display 106.

In accordance with embodiments of the present invention, a user may enter user input on a display for stopping display of an image that is being displayed on another display. Continuing the aforementioned example, the cashier may enter another predetermined touch input into the display 104. The touch input may be received by the display controller 108. In response to receipt of the touch input, the display controller 108 may control the display 104 to stop displaying the image. In one example, the multi-touch gestures shown in FIGS. 3A and 3B may be used for toggling on and off display of an image on the display 104 that is being displayed on the display 106. For example, the multi-touch gesture depicted in FIG. 3A may be entered to activate display of the image, and the multi-touch gesture depicted in FIG. 3B may be entered to de-activate display of the image.

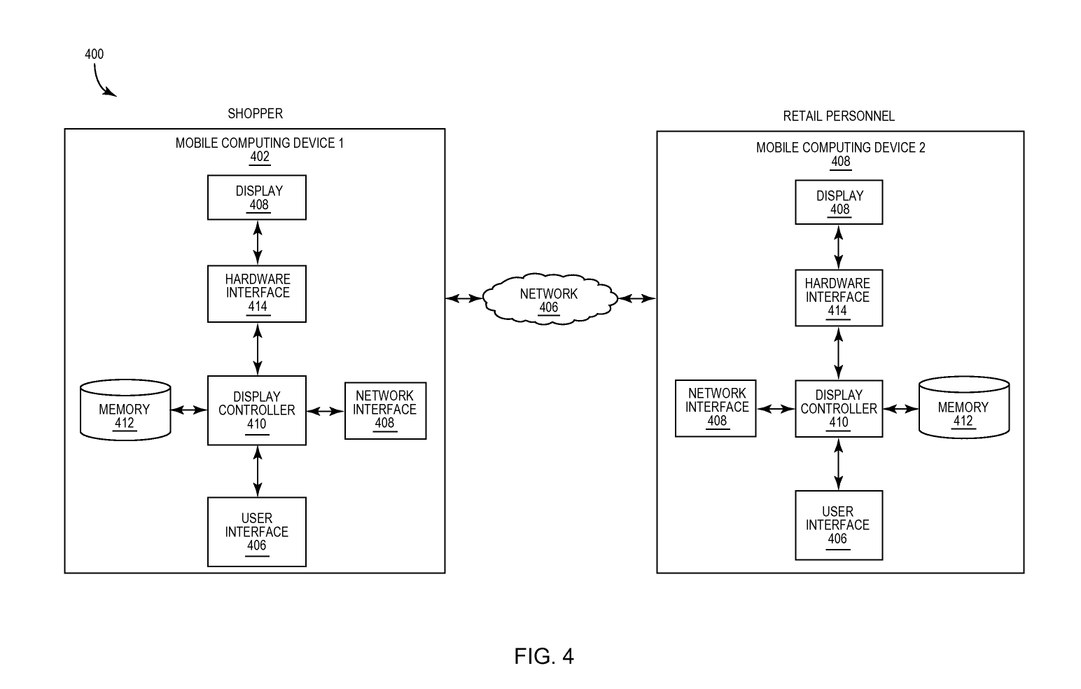

FIG. 4 illustrates a block diagram of another example system 400 for controlling display of an image received from a secondary display in accordance with embodiments of the present invention. Referring to FIG. 4, the system 400 includes mobile computing devices 402 and 404. In this example, mobile computing device 402 is a mobile phone, and mobile computing device 404 is a tablet computer. The computing devices 402 and 404 may suitably communicate with each other or other computing devices to exchange data, images, and the like. Communication between the computing devices 402 and 404 may be implemented via any suitable technique and any suitable communications network. For example, the computing devices 402 and 404 may interface with one another to communicate or share data over communications network 406, such as, but not limited to, the Internet, a local area network (LAN), or a wireless network, such as a cellular network. As an example, the computing devices 402 and 404 may communicate with one another via a WI-FI® connection or via a web-based application. The computing devices 402 and 404 may each include a network interface 408 configured to interface with the network 406. A display controller 410 may interact with the network interface 408 for sending and receiving data and images.

The display controller 410 may be implemented by hardware, software, firmware, of combinations thereof. For example, software residing on a memory 412 may include instructions implemented by a processor for carrying out functions of the display controller 410 disclosed herein.

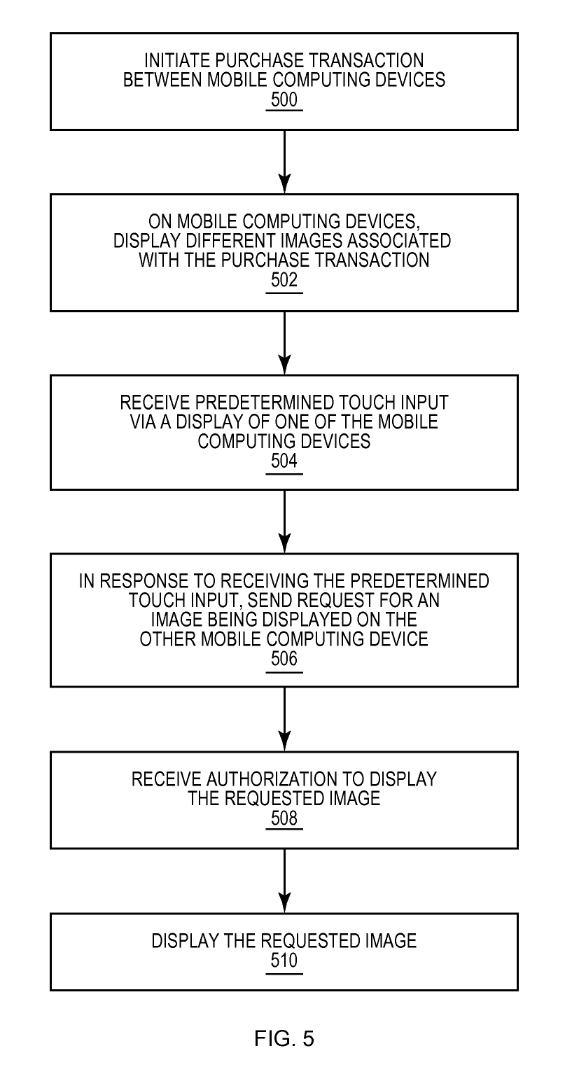

In accordance with embodiments of the present invention, FIG. 5 illustrates a flowchart of another example method for controlling display of images received from a secondary display device. The method of FIG. 5 is described as being implemented by the system 400 shown in FIG. 4, although the method may be implemented by any suitable system. The method may be implemented by hardware, software, and/or firmware of the mobile computing devices 402 and 404 or any suitable computing device.

Referring to FIG. 5, the method includes initiating 500 a purchase transaction between mobile computing devices. For example, a shopper and retail personnel within a retail environment may use mobile computing devices 402 and 404, respectively, for conducting a purchase transaction. The mobile computing devices 402 and 404 may establish a communication link with one another via the network 406 or directly via a suitable wireless connection, such as a BLUETOOTH® communication link. Applications residing on the mobile computing devices 402 and 404 may provide an interface and functionality for allowing the devices to connect and to initiate a purchase transaction. The shopper and retail personnel may interact with their respective devices 402 and 404 by use of a user interface 406 and a touch screen display 408.

The method of FIG. 5 includes displaying 502, on the mobile computing devices, different images associated with the purchase transaction. Continuing the aforementioned example, the mobile computing device 402 operated by the shopper may display images with information about products to be purchased, financial transaction information, and the like. The mobile computing device 404 operated by the retail personnel may display information about products within the retail environment, pricing information, or other information hidden from the shopper. The images may be displayed separately within windows of a windows computing environment or otherwise partitioned for facilitating viewing by the shopper or retail personnel.

The method of FIG. 5 includes receiving 504 predetermined touch input via a display of one of the mobile computing devices. Continuing the aforementioned example, the retail personnel may want to view one or more images being displayed on the display 408 of the shopper's device 402. To do so, the retail personnel may touch the display screen of his or her device 404 to enter a multi-touch gesture for requesting access to and display of the image. The display 408 and/or user interface 406 of the retailer personnel's device 404 may provide options for specifying the image(s) and may provide information about the image(s) to aide in selection. The retail personnel may interact with the display 408 and/or user interface 406 for specifying the image(s).

The method of FIG. 5 includes sending 506 a request for an image being displayed on the other mobile computing device in response to receiving the predetermined touch input. Continuing the aforementioned example, the display controller 410 of the retail personnel's device 404 may receive the multi-touch gesture input and selection of the image(s). In response to receipt of the input, the display controller 410 may control the network interface 408 to communicate to the shopper's device 402 a request for the specified image, which is being displayed on the device 402.

Alternative to requesting an image, the retail personnel's device 404 may have been previously pre-authorized to receive images from the shopper's device 402. In this case, an authorization request may not be needed. Rather, the communication to the device 402 may specify an image without an authorization request. As an example, pre-authorization may be previously approved when a shopper registers for a customer loyalty program for the retailer.

The method of FIG. 5 includes receiving 508 authorization to display the requested image. Continuing the aforementioned example, the shopper's device 402 may receive the communication from the retail personnel's device 404. In response to receipt of the communication, the display controller 410 of the device 402 may determine whether the device 404 is approved. If the request is not approved, the display controller 410 of the device 402 may communicate notification of a denial of the request to the device 404, and the display 408 may display the notification. In contrast, if the request is approved, the display controller 410 may control the network interface 408 to communicate the specified image(s) to the retail personnel's device 404. The one of more images communicated to the device 404 may be one or more portions or the entirety of the content being displayed on the device 402.

The method of FIG. 5 includes displaying 510 the requested image. Continuing the aforementioned example, the retail personnel's device 404 can receive the communicated image(s) from the shopper's device 402. The display controller 410 can control a hardware interface 414 and the display 408 to display the received image(s). As an example, the displayed image may be a snapshot of content being displayed on the device 402. As another example, the image may be periodically or constantly refreshed to mirror the image being displayed on the shopper's device 402. Further, the image displayed on the device 404 may be the same or substantially the same as the image being displayed on the device 402. As an example, the image displayed on the device 404 may be reformatted based on different display screen sizes, preferences, settings, and the like. When the retail personnel desires, he or she may touch the display screen of the display 408 of the device 404 to enter predetermined user input for stopping display of the image in accordance with embodiments of the present invention.

In accordance with embodiments of the present invention, a user at a computing device may enter user input for controlling a display of another computing device. For example, referring to FIG. 4, a user of the computing device 404 may enter user input via the display 408 and/or user interface 406 for controlling the display 408 of the computing device 402. The display controller 410 may generate one or more control commands corresponding to the user input in response to receiving the user input. Subsequently, the control command(s) may be communicated to the computing device 402. The control command(s) may be received at the display controller 410 of the device 402. As an example, the control command(s) may be used as input to an application residing on the device 402. The control command(s) may be used for controlling display of one or more images generated based on the command(s).

In accordance with embodiments of the present invention, a record of a control command may be stored. For example, a control command provided by a mobile device of retail personnel may be stored on one of the mobile devices or another computing device. Further, the stored control command may be stored and associated with identification of the user who generated the control command. As a result, a record can be maintained of other computing device users who have submitted commands for controlling a computing device.

In accordance with embodiments of the present invention, a predetermined user input may be detected or determined based on more than one particular type of multi-touch gesture. In an example, a user may contact a display screen with either four or five fingers for inputting a multi-touch gesture. Referring to FIG. 3A, for example, initial placement of fingers may be at the four circles 302, 304, 306, and 308 for a multi-touch gesture. Alternatively, for example, the initial placement of fingers may be at the five circles 300, 302, 304, 306, and 308 for the same multi-touch gestures. This feature may be useful, for example, to detect a gesture when a user attempts to gesture with five fingers but actually only makes contact with four fingers.

In accordance with embodiments of the present invention, a user may input user input for simultaneously interacting with multiple other displays. For example, retail personnel may be working with more than one shopper at the same time. In this example, the shopper may input user input in accordance with embodiments of the present invention for switching between shopper displays or displaying all of the shopper displays at the same time. In another example, the retail personnel may select to view multiple different displays of the same shopper. In this example, the shopper may be using a mobile computing device and a retailer-provided display, and the retailer personnel may select to view all of the displays of the same shopper.

In accordance with embodiments of the present invention, a suitable operating system residing on a computing device may allow a user to switch between an application mode (e.g., via extended desktop) to a mirrored mode in which images of another display are displayed. This feature may be beneficial, for example, in retail environment settings so that retail personnel can view purchase transaction information displayed on a shopper's computing device.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
using at least a processor and memory for:
controlling a first display to display a first image;
receiving predetermined touch input via the first display; and
in response to receiving the predetermined touch input, controlling the first display to display a second image that is substantially the same as a third image displayed on a second display.

2. The method of claim 1, further comprising controlling the first display to display the first and second images within first and second portions, respectively, of a display screen of the first display.

3. The method of claim 1, wherein the predetermined touch input is a multi-touch gesture.

4. The method of claim 3, wherein the multi-touch gesture includes a multi-touch, drag contact of a display screen of the first display.

5. The method of claim 1, further comprising receiving data of the third image from a computing device that controls the second display.

6. The method of claim 1, wherein the second image is the same as the third image.

7. The method of claim 1, wherein the first and second displays are within a point of sale (POS) system.

8. The method of claim 1, wherein the first display is a component of a first computing device, and
wherein the second display is a component of a second mobile computing device.

9. The method of claim 1, wherein the predetermined touch input is a first predetermined touch input, and
wherein the method further comprises:
receiving a second predetermined touch input via the first display; and
in response to receiving the second predetermined touch input, controlling the first display to stop display of the second image.

10. The method of claim 9, wherein the second predetermined touch input is a multi-touch gesture.

11. The method of claim 10, wherein the multi-touch gesture includes a multi-touch, drag contact of a display of the first display.

12. The method of claim 1, further comprising receiving authorization to display the second image, and
wherein controlling the first display to display the second image comprises controlling the first display to display the second image in response to receiving the authorization.

13. The method of claim 1, further comprising:
receiving user input for interacting with a computing device that controls the second display; and
communicating a control command associated with the computing device in response to receiving the user input.

14. The method of claim 13, wherein the control command controls display of the second display.

15. The method of claim 13, further comprising storing a record of the control command communicated to the computing device.

16. A computing device comprising:
a first display; and
a display controller configured to:
control the display to display a first image;
receive predetermined touch input via the first display; and
control the first display to display a second image that is substantially the same as a third image displayed on a second display in response to receiving the predetermined touch input.

17. The computing device of claim 16, wherein the predetermined touch input is a multi-touch gesture.

18. The computing device of claim 17, wherein the multi-touch gesture includes a multi-touch, drag contact of a display screen of the first display.

19. The computing device of claim 16, wherein the first display is a component of a first computing device, and
wherein the second display is a component of a second mobile computing device.

20. The computing device of claim 16, wherein the predetermined touch input is a first predetermined touch input, and
wherein the display controller is configured to:
receive a second predetermined touch input via the first display; and
control the first display to stop display of the second image in response to receiving the second predetermined touch input.

21. The computing device of claim 20, wherein the second predetermined touch input is a multi-touch gesture.

22. The computing device of claim 21, wherein the multi-touch gesture includes a multi-touch, drag contact of a display of the first display.

23. The computing device of claim 16, wherein the display controller is configured to:
receive authorization to display the second image, and
control the first display to display the second image in response to receiving the authorization.

24. The computing device of claim 16, wherein the display controller is configured to receive user input for interacting with a computing device that controls the second display; and
wherein the computing device further comprises a network interface configured to communicate a control command associated with the computing device in response to receiving the user input.

25. The computing device of claim 24, wherein the control command controls display of the second display.
